(19) United States
(12) Patent Application Publication
(10) Pub. No.: US 2010/0321655 A1
(43) Pub. Date: Dec. 23, 2010

(54) EXPOSURE SYSTEM, CONTROL APPARATUS OF EXPOSURE APPARATUS, AND METHOD OF MANUFACTURING DEVICE

(75) Inventor: Hiroshi Tanaka, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/818,477

(22) Filed: Jun. 18, 2010

(30) Foreign Application Priority Data
Jun. 23, 2009 (JP) 2009-149175

(51) Int. Cl. G03B 27/42

(52) U.S. Cl. 355/53

(57) ABSTRACT

A system includes a plurality of exposure apparatuses each detecting a position of a mark formed on a substrate under a detection condition, positioning the substrate in accordance with the detected position, and exposing the positioned substrate; and a controller configured, if a detection condition for a certain process is changed in one of the plurality of exposure apparatuses for an error occurred in the one exposure apparatus while another exposure apparatus of the plurality of exposure apparatuses is processing a lot including a plurality of substrates for the certain process, to preset a detection condition in the other exposure apparatus in accordance with the changed detection condition after a process of detecting a position of a mark of a substrate currently being processed in the lot is completed and before a process of detecting a position of a mark of a next substrate in the lot is started.

### BACKGROUND OF THE INVENTION

1. Field of the Invention

The present invention relates to an exposure system including a plurality of exposure apparatuses, a control apparatus for controlling a plurality of exposure apparatuses, and a method of manufacturing a device by using the exposure system.

2. Description of the Related Art

As the micropatterning of patterns to be formed advances and the density of the patterns increases, an exposure apparatus for manufacturing a semiconductor device is required to form an image of an original pattern on a substrate with higher resolution. Since the resolution depends on the numerical aperture (NA) of a projection optical system and the wavelength of exposure light, the approach of increasing the resolution uses a method of increasing the NA of the projection optical system, or a method of shortening the exposure wavelength. In the latter method, a light source for generating the exposure light has changed from a g-line light source to an i-line light source, and has further changed from the i-line light source to an excimer laser. Also, oscillation wavelengths of 248 and 193 nm are put into practical use for the excimer laser. Presently, an EUV exposure method using a wavelength of 13 nm is being examined as a candidate for a next-generation exposure method.

On the other hand, the semiconductor device manufacturing processes have been diversified, and a CMP (Chemical Mechanical Polishing) process is used as a planarization technique of solving the problem of insufficient depth of the exposure apparatus. The structures and materials of semiconductor devices are also various. For example, a P-HEMT (Pseudomorphic High Electron Mobility Transistor) and M-HEMT (Metamorphe-HEMT) formed by combining compounds such as GaAs and InP have been proposed. In addition, an HBT (Heterojunction Bipolar Transistor) using, for example, SiGe or SiGeC has been proposed.

Furthermore, as the micropatterning of patterns advances, requirements for the alignment between an original on which a pattern is formed and a substrate onto which the pattern is to be transferred are becoming severer. The accuracy required of the alignment is ⅓ the pattern line width. For example, the accuracy required for 90-nm design is ⅓, that is, 30 nm.

In the alignment of a substrate, however, a WIS (Wafer Induced Shift) caused by the manufacturing process or a wafer process error poses a problem. The WIS degrades the performance of a semiconductor device and decreases the yield of semiconductor device manufacture. Examples of the WIS are a shift by which the structure of an alignment mark becomes asymmetric owing to the influence of a planarization process such as a CMP process, and a shift by which the shape of a resist to be applied on a substrate becomes asymmetric. In addition, as a semiconductor device is manufactured through a plurality of processes, the optical conditions for alignment mark measurement change from one process to another. This changes the WIS amount from one process to another.

FIG. 8 is an exemplary view showing the relationship between semiconductor device manufacturing processes and alignment marks. In the semiconductor device manufacturing processes, a layer LY0 is initially formed, and an alignment mark TLY01 for aligning a layer LY1 and an alignment mark TLY02 for aligning a layer LY2 are formed on the layer LY0. The layer LY1 is aligned with the layer LY0 by detecting the alignment mark TLY01 formed on the layer LY0. The layer LY2 is aligned with both the layers LY1 and LY0 by detecting the position of an alignment mark TLY12 formed on the layer LY1 and the position of the alignment mark TLY02 formed on the layer LY0. Layers LY3, LY4, and LY5 are aligned with the layer LY2 by detecting an alignment mark TLY23 formed on the layer LY2. When forming the layer LY5, the alignment mark TLY23 after the formation of the layers LY3 and LY4 is observed. Accordingly, the influence of the plurality of processes appears on the alignment accuracy of the layer LY5.

To solve this problem, a method that prepares a plurality of alignment parameters and determines an optimum alignment parameter for each process may be useful. Conventionally, a superposition test is conducted by actually exposing substrates to radiant energy by using several alignment parameters, thereby determining an alignment parameter by which the most favorable superposition test result is obtained. However, this method requires an enormous time to determine an alignment parameter.

In consideration of the above problem, Japanese Patent Laid-Open No. 04-032219 has proposed a method of determining an alignment parameter, without performing any wafer exposure and superposition test, by using an evaluation index that is a value obtained by quantitating the amounts of asymmetry and contrast of an alignment mark signal.

Japanese Patent Laid-Open No. 2004-228327 has disclosed a method pertaining to the tuning of an alignment parameter for detecting a mark. Japanese Patent Laid-Open No. 11-283912 has disclosed a method of automatically tuning, for global alignment measurement, the positions and number of measurement marks as alignment parameters for achieving a high measurement accuracy and high throughput at the same time.

Although the various measurement parameter tuning methods have been proposed, any of these proposals does not reflect the tuning of a parameter in one exposure apparatus on other exposure apparatuses. Therefore, the manufacture sometimes stops whenever the same inconvenience occurs in a plurality of exposure apparatuses for executing the same process.

### SUMMARY OF THE INVENTION

The present invention provides, for example, an exposure system including a plurality of exposure apparatuses and advantageous in productivity.

One of aspects of the present invention provides an exposure system including a plurality of exposure apparatuses each of which detects a position of a mark formed on a substrate under a detection condition, positions the substrate in accordance with the detected position, and exposes the positioned substrate to radiant energy, the system comprising a controller configured, if a detection condition for a certain process is changed in one of the plurality of exposure apparatuses for an error occurred in the one exposure apparatus while another exposure apparatus of the plurality of exposure apparatuses is processing a lot including a plurality of substrates for the certain process, to preset a detection condition in the other exposure apparatus in accordance with the changed detection condition after a process of detecting a position of a mark of a substrate currently being processed in the lot is completed and before a process of detecting a position of a mark of a next substrate in the lot is started.

Further features of the present invention will become apparent from the following description of exemplary embodiments with reference to the attached drawings.

### BRIEF DESCRIPTION OF THE DRAWINGS

FIG. 1 is a view schematically showing an example of the arrangement of an exposure apparatus in an exposure system of the first embodiment of the present invention;

FIG. 2 is a view schematically showing an example of the arrangement of a detection optical system;

FIGS. 3A and 3B are exemplary views showing an alignment mark formed on a substrate;

FIG. 4 is an exemplary view showing a mark image signal;

FIG. 5 is a view schematically showing the exposure system of the first embodiment of the present invention;

FIG. 6 is a view schematically showing an exposure system of the second embodiment of the present invention;

FIG. 7 is a view schematically showing the operation of the exposure system of the first embodiment of the present invention; and

FIG. 8 is an exemplary view showing the relationship between semiconductor device manufacturing processes and alignment marks.

### DESCRIPTION OF THE EMBODIMENTS

Embodiments of the present invention will be explained below with reference to the accompanying drawings.

### First Embodiment

An exposure system of the first embodiment of the present invention includes a plurality of exposure apparatuses. Each exposure apparatus detects the position of a mark formed on a substrate (for example, a wafer or glass plate) under a preset detection condition, aligns the substrate and an original (also called a reticle or mask) in accordance with the detection result, and exposes the substrate to radiant energy. The plurality of exposure apparatuses can be arranged in one factory, and can also be arranged in a plurality of factories.

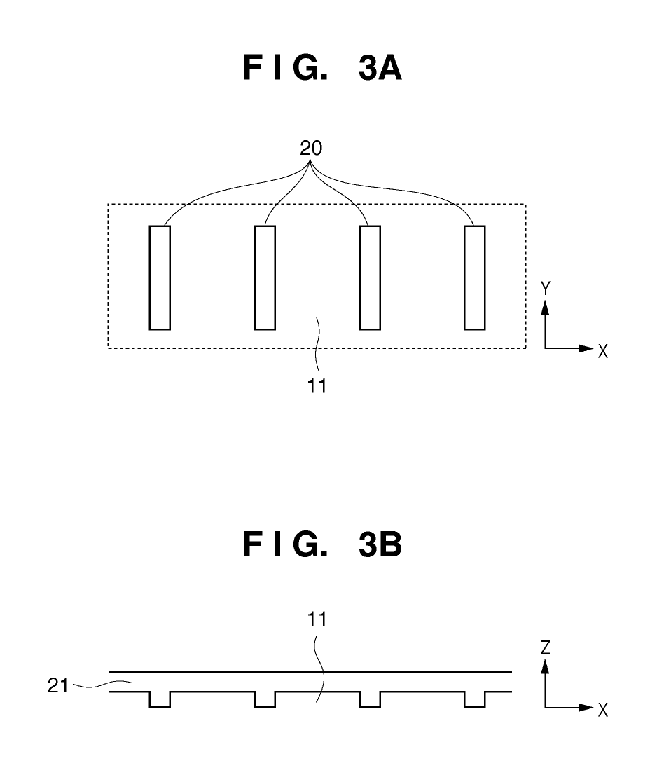

FIG. 1 is a view schematically showing an example of the arrangement of the exposure apparatus in the exposure system of the first embodiment of the present invention. An exposure apparatus 1 includes, for example, a projection optical system 3, substrate stage 6, detection optical system 7, processor 16, controller 17, storage unit 18, and console 19. The projection optical system 3 projects an original 2 having a circuit pattern onto a substrate 4. The substrate stage 6 has a substrate chuck 5 for holding the substrate 4 on which an underlying pattern and an alignment mark (to be referred to as a mark hereinafter) are formed in a preceding step, and aligns the substrate 4 held by the substrate chuck 5. The detection optical system 7 senses, as a mark image, an image of a mark 11 as shown in FIGS. 3A and 3B formed on the substrate 4, and provides the mark image to the processor 16. The processor 16 detects the position of the mark 11 by performing signal processing on the mark image based on a preset parameter. The controller 17 controls each component of the exposure apparatus 1, and, for example, determines the detection condition for detecting the position of the mark 11. The detection condition for detecting the position of the mark 11 can automatically be determined in accordance with a preinstalled program, and can also manually be determined.

FIG. 5 is a view showing an outline of the configuration of the exposure system of the first embodiment of the present invention. An exposure system ES includes a control apparatus (controller) 23, a database 24, and a plurality of exposure apparatuses 1a, 1b, and 1c. The exposure apparatuses 1a, 1b, and 1c each have the same arrangement as that of the exposure apparatus 1 shown in FIG. 1.

FIG. 7 is a view schematically showing the operation of the exposure system ES of the first embodiment of the present invention. FIG. 7 shows an example in which when the detection condition of the mark 11 is changed in the exposure apparatus 1a of the plurality of exposure apparatuses 1a to 1c, the detection condition in the exposure apparatuses 1b and 1c of the plurality of exposure apparatuses 1a to 1c is preset in response to the change and in accordance with the changed detection condition. Steps S101 to S107 indicate the operation of the exposure apparatus 1a. Steps S201 to S210 indicate the operation of the exposure apparatuses 1b and 1c. The controller 17 of the exposure apparatus 1a controls its operation. The controllers 17 of the exposure apparatuses 1b and 1c control their operations. The control apparatus 23 as a host control apparatus can control the operations of the exposure apparatuses 1a, 1b, and 1c. The processes in steps S201, S202, S203, S206, and S207 are respectively the same as those in steps S101, S102, S103, S106, and S107.

In step S101, the substrate 4 is loaded into the exposure apparatus 1a. In step S102, the exposure apparatus 1a presets a parameter stored in the storage unit 18 as the detection condition for detecting the position of the mark 11 formed on the substrate 4.

In step S103, the exposure apparatus 1a detects the position of the mark 11 of the substrate 4 under the preset detection condition (parameter). In step S106, the exposure apparatus 1a aligns the substrate 4 and original 2 in accordance with the detection result of the position of the mark 11, and exposes the substrate 4 to radiant energy. In step S107, the exposure apparatus 1a determines whether the processing of all substrates of a lot to be processed is complete. If NO in step S107, the process returns to step S101.

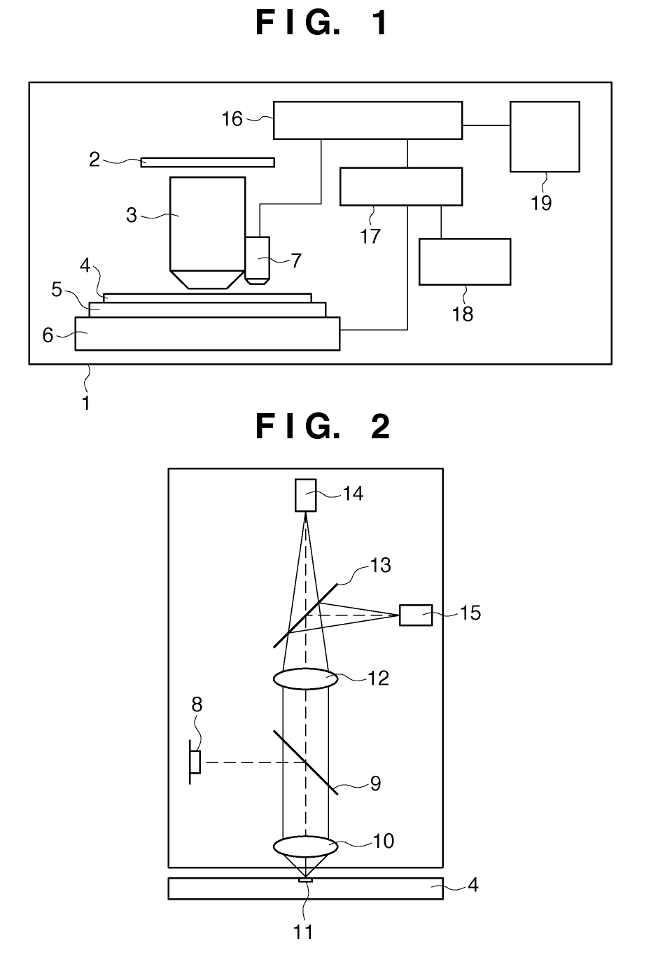

The detection of the position of the mark 11 in step S103 will be explained below. FIG. 2 is a view schematically showing an example of the arrangement of the detection optical system 7. Illumination light from a light source 8 is reflected by a beam splitter 9, and illuminates the mark 11 on the substrate 4 through a lens 10. Diffracted light from the mark 11 passes through the lens 10, the beam splitter 9, and a lens 12, and is split by a beam splitter 13, thereby forming images of the mark 11 on the imaging surfaces of image sensors (for example, CCD sensors) 14 and 15. The image sensors 14 and 15 sense the mark 11 as mark images, and provide the mark images to the processor 16.

The lenses 10 and 12 enlarge the images of the mark 11 by a magnification at which the resolution can satisfy the detection accuracy, and form the enlarged images on the imaging surfaces of the image sensors 14 and 15. The image sensors 14 and 15 are arranged to detect the positions of the mark 11 in the X and Y directions, respectively. As the principles of position detection in the X and Y directions are the same, position detection in the X direction will be explained below.

First, the mark 11 will be explained with reference to FIGS. 3A and 3B. In an example shown in FIGS. 3A and 3B, a plurality of rectangular patterns 20 each having a short side along a measurement direction (the X direction) and a long side along a non-measurement direction (the Y direction) are arranged at predetermined intervals in the measurement direction (X direction). The sectional structure of the mark 11 has a three-dimensional shape formed by etching. The mark 11 is coated with a resist 21.

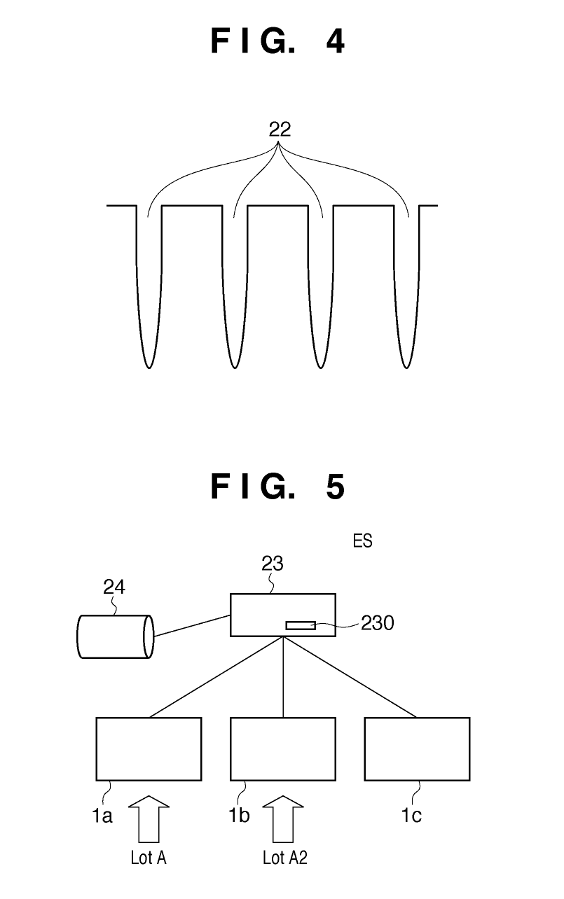

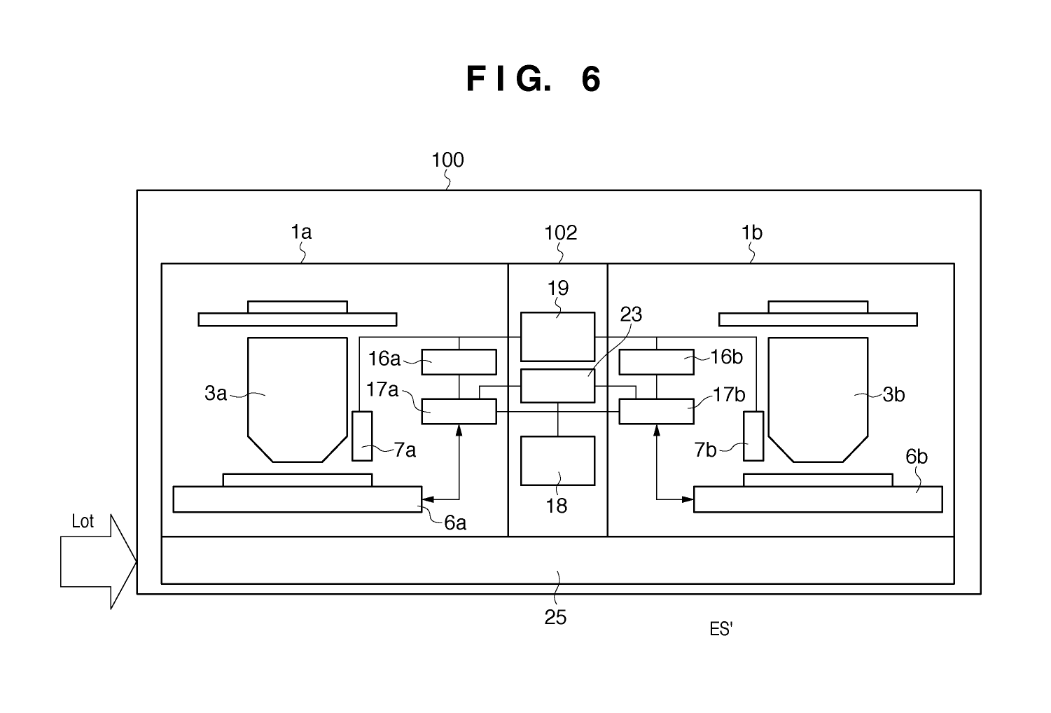

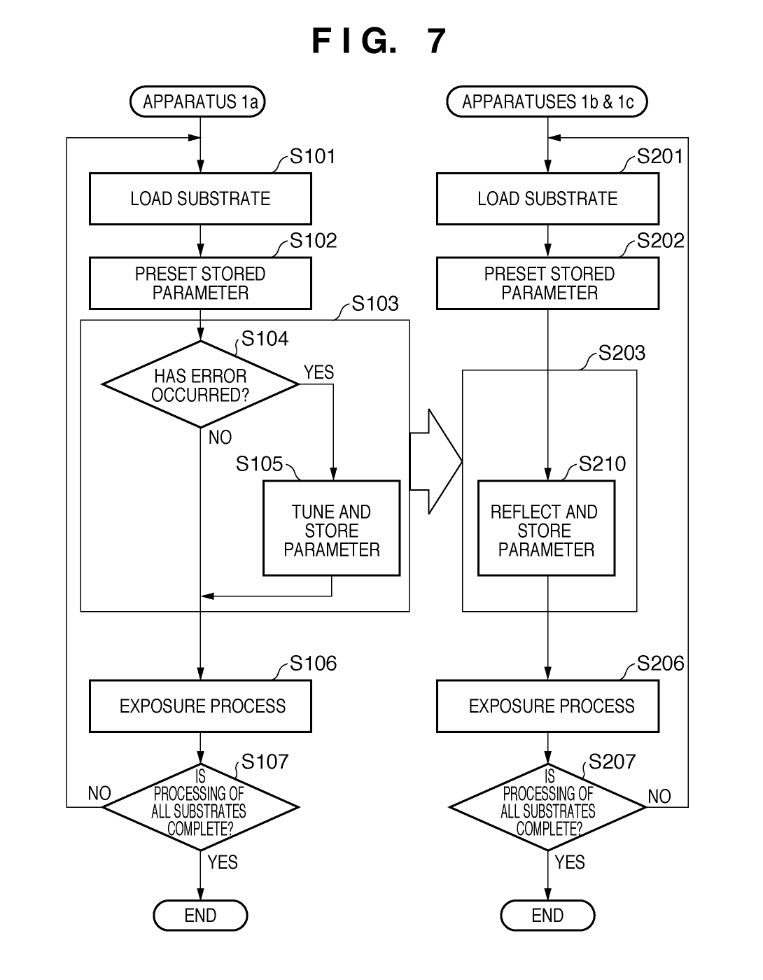

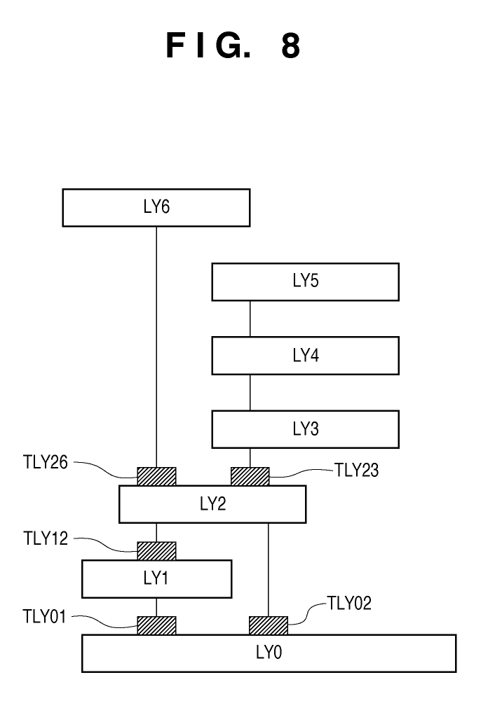

FIG. 4 is an exemplary view showing a mark image signal obtained by sensing an image of the mark 11 by the image sensor 14. The processor 16 processes a mark image signal 22 shown in FIG. 4, thereby detecting the position of the mark 11. In this process, it is possible to, for example, detect the positions of the plurality of patterns 20, and use the average value as the position of the mark 11.

In the detection of the position of the mark 11, an error sometimes occurs because the detection condition (parameter) is inappropriate. For example, if the relationship between the step amount of the mark 11 and the wavelength of the illumination light is inappropriate, the contrast of the mark image signal obtained by sensing an image of the mark 11 becomes insufficient, and this makes the position of the mark 11 impossible to detect. Also, substrate surface processing may make the structure of the mark 11 asymmetrical, and vary the linear components (rotation and magnification) between substrates. Even during the process of measuring one substrate (detecting the position of a mark), it is sometimes impossible to continue the process owing to an error in which deviation from the linear components occurs a number of times.

Step S103 includes steps S104 and S105. In step S104, the presence/absence of the error as described above is determined. If the error has occurred, the process advances to step S105 to tune the detection condition (parameter), preset a new detection condition (parameter), and store the new detection condition in the storage unit 18. If no error has occurred, step S103 is immediately terminated.

The detection condition for detecting the mark position can automatically be changed in accordance with, for example, a preinstalled program, and can also manually be changed. The detection condition for detecting the mark position can include at least one of the condition of signal processing executed by the processor 16 in order to detect the mark position, the coordinates of a mark to be measured, and the illumination condition for illuminating the mark. If a plurality of marks exist, the coordinates of a mark to be measured are obtained by specifying (the positions and number of) marks to be measured. Examples of the illumination condition are the wavelength, bandpass, aperture, and intensity of light that illuminates a mark. In an exposure apparatus including a plurality of detection optical systems, the detection condition can include which of the plurality of detection optical systems is to be used. In addition, the detection condition can include various conditions as described in Japanese Patent Laid-Open Nos. 2004-228327, 04-032219, and 11-283912. Note that the detection condition to be tuned or changed in accordance with the present invention is not limited to the above-mentioned conditions, and can include any conditions concerning the detection of the mark position.

The detection condition can manually be tuned by an operator by, for example, observing the alignment state on a monitor. On the other hand, in the automatic tuning, the preinstalled program can extract an optimum parameter.

When the detection condition (parameter) is changed in step S105, the process advances to step S108, and a setting unit 230 of the control apparatus 23 presets, in response to the change, the changed detection condition in the exposure apparatuses 1b and 1c of the plurality of exposure apparatuses 1a, 1b, and 1c. This presetting can include, for example, the process of saving, in the storage units 18 of the exposure apparatuses 1b and 1c, the detection condition as the newest detection condition of the corresponding process (that can be specified by, for example, a process ID). The control apparatus 23 can also be configured to save the newest detection condition in relation to the process in the database 24.

In this embodiment as described above, when the detection condition is changed in one of a plurality of exposure apparatuses, the changed detection condition is reflected on other exposure apparatuses of the plurality of exposure apparatuses. The process for this reflection can be performed by various procedures. As an example, an exposure apparatus in which the detection condition is changed sends a process ID for specifying the process and information indicating the changed detection condition to the control apparatus 23. In response to this, the control apparatus 23 causes other exposure apparatuses to execute step S210, thereby updating the detection condition of the corresponding process in the other exposure apparatuses. When the detection condition is changed in one exposure apparatus, it is possible to preset the same detection condition as the changed detection condition, or preset a detection condition obtained by adding, for example, an offset value to the changed detection condition, in other exposure apparatuses.

The operation of reflecting the change in detection condition in one exposure apparatus on other exposure apparatuses can be performed immediately after the detection condition is changed in one exposure apparatus, provided that the other exposure apparatuses are not processing a lot or substrate. Note that “a lot” means a processing unit including a plurality of substrates.

On the other hand, consideration must be taken if the detection condition for a certain process is changed in one exposure apparatus while other exposure apparatuses are processing a lot for the certain process. In this case, the detection condition in the other exposure apparatuses can be preset in accordance with the changed detection condition after the process of detecting the position of the mark of a substrate currently being processed in the lot is complete and before the process of detecting the position of the mark of the next substrate is started. The control apparatus 23 or the controllers 17 of the other exposure apparatuses, for example, can control the timing at which the changed detection condition is preset in the other exposure apparatuses.

When the detection condition is changed in one exposure apparatus while other exposure apparatuses are not in operation (an example is a case in which the power supply is not turned on), the control apparatus 23 need only preset the newest detection condition for the corresponding process saved in the database 24 in the other exposure apparatuses after they have started operating.

In this embodiment, when the detection condition is changed in one exposure apparatus, the changed detection condition is reflected on other exposure apparatuses that execute the same process as that of one exposure apparatus. This makes it possible to prevent the same error from occurring in a plurality of exposure apparatuses that execute the same process. Consequently, the overall operating ratio of a plurality of exposure apparatuses can be increased.

The accuracy and result of mark detection can sensitively react with the process conditions such as the thickness of a film to be formed on a substrate, and the pressure of a pad and the type of polishing agent in a polishing step (CMP). In this embodiment, a mark detection condition change that is made necessary by the change in process conditions as described above can rapidly be reflected on a plurality of exposure apparatuses.

### Second Embodiment

The second embodiment of the present invention provides an example in which the present invention is applied to an exposure system including a plurality of exposure apparatuses accommodated in one housing. An exposure system ES′ of the second embodiment includes a plurality of (in this embodiment, two) exposure apparatuses 1a and 1b in a housing 100. The exposure apparatus 1a includes, for example, a projection optical system 3a, substrate stage 6a, detection optical system 7a, processor 16a, and controller 17a. The exposure apparatus 1b includes, for example, a projection optical system 3b, substrate stage 6b, detection optical system 7b, processor 16b, and controller 17b. The projection optical systems 3a and 3b, substrate stages 6a and 6b, detection optical systems 7a and 7b, processors 16a and 16b, and controllers 17a and 17b can respectively have the same functions as those of the projection optical system 3, substrate stage 6, detection optical system 7, processor 16, and controller 17 in the exposure apparatus 1 of the first embodiment.

The exposure system ES′ of the second embodiment includes a common portion 102 to be shared by the plurality of exposure apparatuses 1a and 1b. The common portion 102 includes, for example, a storage unit 18, console 19, and control apparatus (controller) 23 to be shared by the plurality of exposure apparatuses 1a and 1b. The control apparatus 23 can have the same functions as those of the control apparatus 23 of the first embodiment. Note that it is also possible to regard that the controllers 17a and 17b and control apparatus 23 construct one controller. The storage unit 18 can also be regarded as a device integrating the plurality of storage units 18 and the database 24 in the first embodiment.

The exposure system ES′ has a common transport mechanism 25 for loading substrates into the exposure apparatuses 1a and 1b, and unloading substrates from the exposure apparatuses 1a and 1b.

When the mark detection condition is changed in one of the plurality of exposure apparatuses 1a and 1b, the control apparatus 23 presets the changed detection condition in the other of the plurality of exposure apparatuses 1a and 1b, in the second embodiment as well.

### Embodiment of Device Manufacturing Method

A method of manufacturing a device (for example, a semiconductor device or liquid crystal display device) of an embodiment of the present invention will be explained below.

A semiconductor device is manufactured through a pre-process of forming an integrated circuit on a wafer (semiconductor substrate), and a post-process of completing, as a product, the integrated circuit chip on the wafer formed in the pre-process. The pre-process can include a step of exposing a wafer coated with a photosensitive agent to radiant energy by using the above-described exposure apparatus, and a step of developing the wafer exposed to radiant energy in the exposing step. The post-process can include assembling steps (dicing and bonding), and a packaging step (encapsulation). A liquid crystal display device is manufactured through a step of forming a transparent electrode. The step of forming a transparent electrode can include a step of applying a photosensitive agent onto a glass substrate on which a transparent conductive film is deposited, a step of exposing the glass substrate coated with the photosensitive agent to radiant energy by using the above-described exposure apparatus, and a step of developing the glass substrate exposed to radiant energy in the exposing step.

The device manufacturing method of this embodiment is more advantageous than any conventional method in at least one of the device productivity, quality, and production cost.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-149175, filed Jun. 23, 2009, which is hereby incorporated by reference herein in its entirety.

What is claimed is:

1. An exposure system including a plurality of exposure apparatuses each of which detects a position of a mark formed on a substrate under a detection condition, positions the substrate in accordance with the detected position, and exposes the positioned substrate to radiant energy, the system comprising:
a controller configured, if a detection condition for a certain process is changed in one of the plurality of exposure apparatuses for an error occurred in the one exposure apparatus while another exposure apparatus of the plurality of exposure apparatuses is processing a lot including a plurality of substrates for the certain process, to preset a detection condition in the other exposure apparatus in accordance with the changed detection condition after a process of detecting a position of a mark of a substrate currently being processed in the lot is completed and before a process of detecting a position of a mark of a next substrate in the lot is started.

2. A system according to claim 1, wherein the detection condition includes at least one of a condition of signal processing for detecting a position of a mark, a coordinate of a mark to be measured, and an illumination condition for illuminating a mark.

3. A system according to claim 1, wherein the plurality of exposure apparatuses are accommodated in one housing.

4. A system according to claim 3, further comprising a conveyance mechanism configured to convey a substrate,
wherein the plurality of exposure apparatuses are configured to share the conveyance mechanism.

5. A control apparatus for controlling a plurality of exposure apparatuses each of which detects a position of a mark formed on a substrate under a detection condition, positions the substrate in accordance with the detected position, and exposes the positioned substrate to radiant energy, wherein
the control apparatus is configured, if a detection condition for a certain process is changed in one of the plurality of exposure apparatuses for an error occurred in the one exposure apparatus while another exposure apparatus of the plurality of exposure apparatuses is processing a lot including a plurality of substrates for the certain process, to preset a detection condition in the other exposure apparatus in accordance with the changed detection condition after a process of detecting a position of a mark of a substrate currently being processed in the lot is completed and before a process of detecting a position of a mark of a next substrate in the lot is started.

6. A method of manufacturing a device, the method comprising:
exposing a substrate to radiant energy using an exposure system;
developing the exposed substrate; and
processing the developed substrate to manufacture the device,
wherein the exposure system includes a plurality of exposure apparatuses each of which detects a position of a mark formed on a substrate under a detection condition, positions the substrate in accordance with the detected position, and exposes the positioned substrate to radiant energy, the system comprising:
a controller configured, if a detection condition for a certain process is changed in one of the plurality of exposure apparatuses for an error occurred in the one exposure apparatus while another exposure apparatus of the plurality of exposure apparatuses is processing a lot including a plurality of substrates for the certain process, to preset a detection condition in the other exposure apparatus in accordance with the changed detection condition after a process of detecting a position of a mark of a substrate currently being processed in the lot is completed and before a process of detecting a position of a mark of a next substrate in the lot is started.
